(19) United States
(12) Patent Application Publication
(10) Pub. No.: US 2008/0005230 A1
(43) Pub. Date: Jan. 3, 2008

(54) Data Processing Device, Data Processing System, Data Processing Relay Device, and Data Processing Method

(75) Inventor: Yusuke Fujimaki, Tokushima-shi (JP)

Correspondence Address: SUGHRUE MION, PLLC, 2100 PENNSYLVANIA AVENUE, N.W., SUITE 800, WASHINGTON, DC, 20037, US

(73) Assignee: Justsysems Corporation, Tokushima-shi (JP)

(21) Appl. No.: 11/667,664

(22) PCT Filed: Nov. 14, 2005
(86) PCT No.: PCT/JP05/20894

§ 371 Date: May 14, 2007

(30) Foreign Application Priority Data
Nov. 12, 2004 (JP) 2004-329833

(51) Int. Cl. G06F 15/16

(52) U.S. Cl. 709/203

(57) ABSTRACT

A technique that can reduce the load to the ASP server is provided. An application executed in the ASP server is installed into a user terminal 6. The application installed into the user terminal functions as a satellite ASP, exhibiting the same functions as those of the ASP server. When a user transmits a request for receiving ASP services from the ASP server, to the ASP server, the satellite ASP receives the request to execute the application instead of the ASP server.

### FIELD OF THE INVENTION

The present invention relates to a data processing technique, more specifically, to a data processing apparatus that provides an application service.

### BACKGROUND ART

Recently, personal computers and mobile phone terminals have been widely in use, and the situation in which everyone can utilize the Internet has been being prepared. Web services via the Internet have also become widely available.

### DISCLOSURE OF THE INVENTION

### Problems to be Solved by the Invention

Servers of Application Service Providers (ASP) are providing various types of services. In an ASP server, an application is executed to provide services, however, when huge accesses to an ASP server concentrate, the processing speed might be lowered or the system might break down. To overcome these problems, a system ideally must be constructed to endure a temporary maximum accesses, however, such a system is not considered efficient in terms of the cost performance.

The present invention has been made in view of these situations, and a general purpose of the invention is to provide a technique in which the load to a server providing application services can be reduced, and an application can be controlled efficiently in a server/client model.

### MEANS FOR SOLVING THE PROBLEMS

An aspect of the present invention relates to a data processing apparatus. The data processing apparatus includes: means for acquiring an application, which has a function equal to or a part of an application that is executed by a server to provide services, from a server via a net work, and installing the application; and means for acquiring a request to the server, and executing the application instead of the server.

The application may be installed in a client's terminal, or in an apparatus connected between a client terminal and the server.

Another aspect of the present invention relates to a data processing apparatus. The apparatus includes: a module acquisition unit that downloads at least some of a plurality of functional modules which make up an application software, from an external apparatus; an input screen display unit that displays an input screen for accepting an input operation from a user; an operation detecting unit that detects a user's input operation on the input screen; a main executing body selecting unit that selects at least either of a local module, which is a functional module downloaded to the apparatus itself, or a remote module, which is a functional module stored in an external apparatus, depending on whether a local module, which is capable of executing the data processing, is located or not, as the main executing body for the data processing in accordance with the user's input operation; a local execution control unit that makes the local module execute the data processing in accordance with the user's input operation, when a local module is selected as the main executing body; a remote execution control unit that transmits processing request information for requesting an external apparatus to execute the data processing in accordance with the user's input operation, and receives a resulting information of the data processing from the external apparatus, when a remote module is selected as the main executing body; and a result display unit that displays a result of the data processing executed by at least either of a local module or a remote module, on the screen. The main executing body selecting unit selects at least either of a local module or a remote module, even when a user's input does not include information that can identify either of a local module or a remote module as the main executing body.

In this apparatus, at least some of functional modules, which are to be download targets as a local module, may be executable in both an external apparatus and an apparatus itself.

The input screen display unit may display an input screen as a screen for indicating to transmit processing request information to an external apparatus, and the main executing body selecting unit may acquire the processing request information via the input screen and may select a local module as the main executing body, when the local module capable of executing the data processing in accordance with the processing request information, is located.

The main executing body selecting unit may give priority to selection of a local module as the main executing body, when the communication with an external apparatus is in an off-line state.

The input screen display unit may display an input screen in a way in which input screens for accepting an input operation for a remote module and a local module, are to be substantially the same.

The apparatus may further include an application selecting unit that detects a user's input for selecting an application software to be executed. The module acquisition unit may set a functional module included in the selected application software, to be a download target from an external apparatus.

The apparatus may further include a module selecting unit that detects a user's input for selecting a functional module to be a download target, from a plurality of functional modules included in an application software. The module acquisition unit may set the selected functional module to be a download target from an external apparatus.

The apparatus may further include an update information receiving unit that receives the update information indicating a remote module in an external apparatus has been modified. The module acquisition unit may freshly download a modified remote module, upon receiving the update information.

Another aspect of the present invention relates to a data processing system. The data processing system includes an above-mentioned data processing apparatus and a sever apparatus. The server apparatus includes: a module holding unit that holds a plurality of functional modules that make up an application software; a module transmitting unit that transmits at least some of a plurality of the functional modules to the data processing apparatus, as a local module to be held in the data processing apparatus; a processing request receiving unit that receives the processing request information which is issued by the data processing apparatus to request an execution of a data processing; an execution control unit that allows a functional module held to execute a requested data processing; and a processing result transmitting unit that transmits a result of the data processing to the data processing apparatus, as processing result information.

Still another aspect of the present invention relates to a data processing relay apparatus. The apparatus includes: a module acquisition unit that downloads at least some of a plurality of functional modules which make up an application software, from a first external apparatus; a processing request receiving unit that receives the processing request information for requesting an execution of a data processing from a second external apparatus; a main executing body selecting unit that selects either of a local module which is a functional module downloaded to an apparatus itself, or a remote module which is a functional module stored in a first external apparatus, depending on whether a local module capable of executing a data processing is located or not, as the main executing body of executing a data processing; a local execution control unit that makes a local module execute an requested data processing, when a local module is selected as the main executing body; a remote execution control unit that transmits processing request information for requesting the first external apparatus to execute a requested data processing, when a remote module is selected as the main executing body, and that receives resulting information showing a result of the data processing from the first external apparatus; and a processing result transmitting unit that transmits a processing result of a data processing by at least either of a local module or a remote module, to a second external apparatus, as the processing result information.

The apparatus may further include a module transmitting unit that transmits at least some of the functional modules downloaded from a first external apparatus to a second external apparatus so that a part of the functions of an application software are set to be executable in a second external apparatus.

Note that any combination of the aforementioned components or any manifestation of the present invention realized by modifications of a method, device, system, and so forth, is effective as an embodiment of the present invention.

### ADVANTAGES

According to the present invention, a technique that reduces the load to a server offering application services can be provided.

### BRIEF DESCRIPTION OF THE DRAWINGS

FIG. 1 is a diagram which shows a structure of a data processing system according to the first embodiment.

FIG. 2 is a diagram which shows a structure of a data processing system according to the second embodiment.

FIG. 3 is a diagram which shows a structure of an application software in a data processing system according to the first embodiment.

FIG. 4 is a functional block diagram of an ASP server.

FIG. 5 is a functional block diagram of the user satellite ASP.

FIG. 6 is a screen view which shows an input screen for searching routes with respect to a route search application installed in the user satellite ASP.

FIG. 7 is a screen view which shows an application selecting screen for selecting an application to be installed in the user satellite ASP.

FIG. 8 is a screen view which shows a module selecting screen for selecting a module to be installed in the user satellite ASP.

FIG. 9 is a flow chart showing a data processing in the user satellite ASP in the first embodiment.

FIG. 10 is a sequence diagram which shows a process in which the user satellite ASP updates a local module, in the first embodiment.

FIG. 11 is a diagram which shows a structure of an application software, in a data processing system according to the second embodiment.

FIG. 12 is a functional block diagram of the relay satellite ASP.

FIG. 13 is a flow chart showing a data processing in the relay satellite ASP in the second embodiment.

FIG. 14 is a sequence diagram which shows a process in which the relay satellite ASP or the user satellite ASP updates a module in the second embodiment.

### DENOTED NUMERALS

1 DATA PROCESSING SYSTEM
2 INTERNET
3 ASP SERVER
4 ROUTER APPARATUS
5 SATELLITE ASP
6 USER TERMINAL
8 RELAY SATELLITE ASP
9 USER SATELLITE ASP
100 DOWNLOAD PROCESSING UNIT
102 DOWNLOAD REQUEST RECEIVING UNIT
104 MODULE TRANSMITTING UNIT
106 UPDATE INFORMATION TRANSMITTING UNIT
110 DATA PROCESSING CONTROL UNIT
112 EXECUTION REQUEST RECEIVING UNIT
114 PROCESSING RESULT TRANSMITTING UNIT
116 EXECUTION UNIT
120 MODULE HOLDING UNIT
130 DOWNLOAD PROCESSING UNIT
132 DOWNLOAD REQUEST TRANSMITTING UNIT
134 MODULE RECEIVING UNIT
136 UPDATE INFORMATION RECEIVING UNIT
140 USER INTERFACE PROCESSING UNIT
142 INPUT UNIT
144 DISPLAY UNIT
150 DATA PROCESSING CONTROL UNIT
152 MAIN EXECUTING BODY SELECTING UNIT
154 LOCAL EXECUTING UNIT
156 REMOTE EXECUTING UNIT
158 COMMUNICATION STATE DETECTING UNIT
160 APPLICATION SELECTING UNIT
162 MODULE SELECTING UNIT
170 MODULE HOLDING UNIT
240 DOWNLOAD PROCESSING UNIT
242 DOWNLOAD REQUEST TRANSMITTING UNIT
244 DOWNLOAD REQUEST RECEIVING UNIT
246 MODULE TRANSMITTING UNIT
248 MODULE RECEIVING UNIT
250 UPDATE INFORMATION RECEIVING UNIT
252 UPDATE INFORMATION TRANSMITTING UNIT
260 DATA PROCESSING CONTROL UNIT
262 EXECUTION REQUEST RECEIVING UNIT
264 MAIN EXECUTING BODY SELECTING UNIT
268 LOCAL EXECUTING UNIT
270 REMOTE EXECUTING UNIT
272 COMMUNICATION STATE DETECTION UNIT
274 PROCESSING RESULT TRANSMITTING UNIT
280 MODULE HOLDING UNIT

### THE MOST PREFERRED EMBODIMENT FOR CARRYING OUT THE INVENTION

### First Embodiment

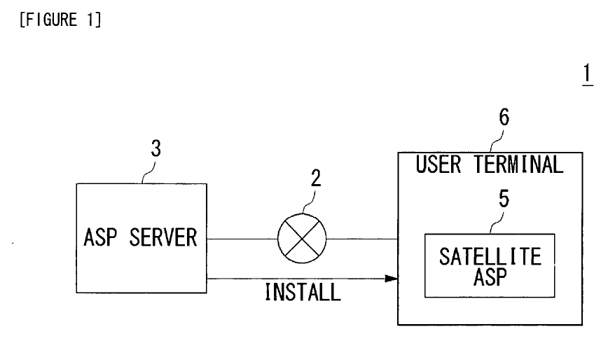

FIG. 1 shows a structure of a data processing system according to the first embodiment. A data processing system 1 includes an ASP server 3 and a user terminal 6. The ASP server 3 and the user terminal 6 are connected together via the Internet 2, and the ASP server 3 provides the user terminal 6 with ASP services such as a mail-order system or an access log analysis.

In the present embodiment, an application that is to be executed in the ASR server 3 can be installed in the user terminal 6. For example, a UI for installing an application in the user terminal 6 may be provided on a Web page provided by the ASP server 3. The ASP server 3 transmits an application to the user terminal 6 so that the application will be installed, when a user requests an installation of an application. An application installed in a user terminal 6 can perform the same functions as that of an ASP server 3, and is hereinafter referred to as a satellite ASP 5.

When a user transmits a request to an ASP server 3 in order to receive an ASP service of an ASP server 3, a satellite ASP 5 receives the request and executes an application on behalf of the ASP server 3, that is, a satellite ASP 5 functions as a proxy server of an application. A satellite ASP 5 functions as a so-called local cache of applications, whereas a conventional proxy server caches contents such as HTML documents or images or the like.

According to such a structure, a function of an ASP server 3 can be transferred to a user's local environment, which leads to the load reduction of an ASP server 3. Further, it is also possible that a user terminal 6 can receive an ASP service, even when a trouble happens in a ASP server 3 or the communication between a user terminal 6 and an ASP server 3 is cut off. Furthermore, the security of an ASP server 3 can be improved. In order to improve the security and the reliability of a satellite ASP 5, a sandbox technology, which makes an application completely executed in a limited region, and a digital signature technology, which proves where an application comes from or a fact that an application have not been modified, may be employed. In a satellite ASP 5, an application runs in a user terminal 6, which has a further advantage that the application can access to a component in a user terminal 6, and a component connected to a user terminal 6, in contrast with an ASP server 3. For example, such an application that acquires images of a digital camera connected to user terminal 6 via USB, can be installed.

Installation of an application may not only be initiated by the user but also be carried out automatically by an ASP server 3 or the system of a user terminal 6 besides by a user.

### Second Embodiment

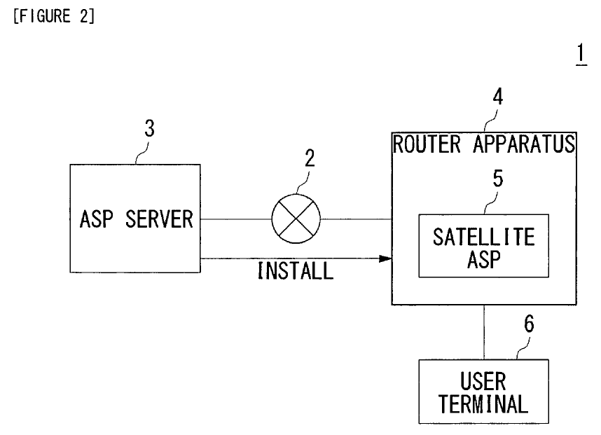

FIG. 2 shows a structure of a data processing system according to the second embodiment. In a data processing system 1 according to the present embodiment, a satellite ASP 5 is installed in a router apparatus 4, instead of a user terminal 6. This makes the satellite ASP 5 available to a plurality of user terminals 6 connected to the router apparatus 4.

Additional description will be made below with respect to the embodiments 1 and 2.

### First Embodiment

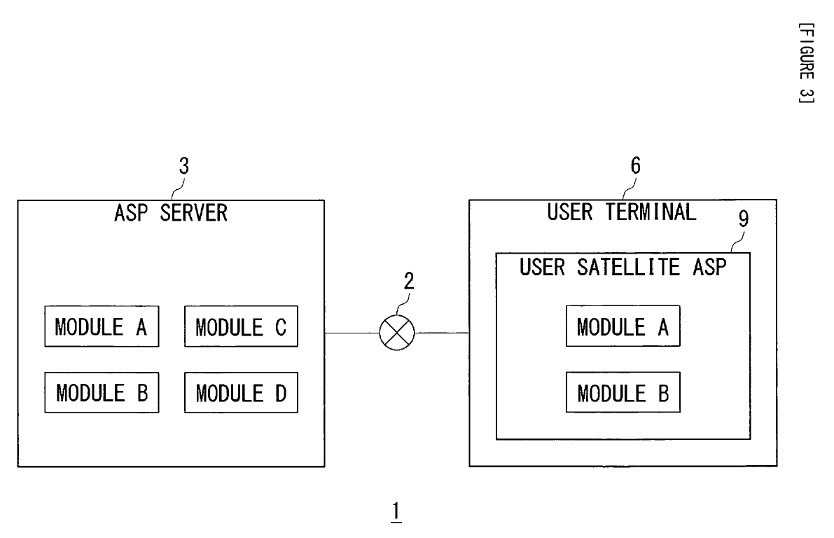

FIG. 3 is a diagram which shows a structure of an application software in a data processing system according to the first embodiment.

Herein, an application comprised of 4 modules: modules A to D, will be described. The functions as a whole application can be exhibited with the cooperation of these modules. For example, an application for searching for routes from the departure place to the destination place, includes various modules such as a module for searching for a location of an input name of a place, a module for identifying a preferable route in accordance with an input, and a module for computing the time required in the identified route, or the like. In such a way, one or more modules execute various kinds of data processing in accordance with a user input, generating a final output. A module itself may be provided in the form of library or the form of execution file, or may be shared by a plurality of applications.

Data of the modules A to D that make up an application, are held in an ASP server 3. A user satellite ASP 9 is installed in a user terminal 6. The referred user satellite ASP 9 is software corresponding to a satellite ASP 5 in FIG. 1. The user satellite ASP 9 holds the module A and module B among the modules held in the ASP server 3. The user satellite ASP 9 acquires these modules from the ASP server 3 via the Internet. In the embodiment shown in the same Figure, the application software is executed basically by the modules A and B of the user satellite ASP 9, and by the modules C and D of the ASP server 3.

In addition, in order to differentiate whether a module is held in an apparatus itself or in an external apparatus, from the point of the user satellite ASP 9, a module such as a module A and B, which is held in the user satellite ASP 9, is referred to as a “local module”, on the other hand, a module such as a module A to D, which is held in the ASP server 3, is referred to as a “remote module”.

Of the modules A to D in the same Figure, the module A is one which can be executed only in the user satellite ASP 9. That is why the user satellite ASP 9 always downloads the module A in order to execute this application. Such a module that is executable solely in the user satellite ASP 9 is referred to as a “module solely for terminals”. The ASP server 3 holds the module A for transferring to the user satellite ASP 9, therefore, the ASP server 3 never executes the module A. In contrast with a conventional ASP model, the module A allows an access to a source in the user terminal 6 to be possible.

The modules B and C are executable in both an ASP server 3 and a user satellite ASP 9. That is why the user satellite ASP 9 may or may not download the module B or C. Such a module executable in both an ASP server 3 and an user satellite ASP 9 is referred to as a “shared module”.

The module D is executable in solely a ASP server 3, and data that should be controlled solely by an ASP server 3, will be controlled by the module D. Such a module executable solely in an ASP server 3 is referred to as a “server-only module”.

In addition, the ASP server 3 may not always be a single unit. That is, each remote module may be executed by a plurality of ASP servers 3. Additionally, the module A or the module D or the like are not essential components in realizing the data processing system 1.

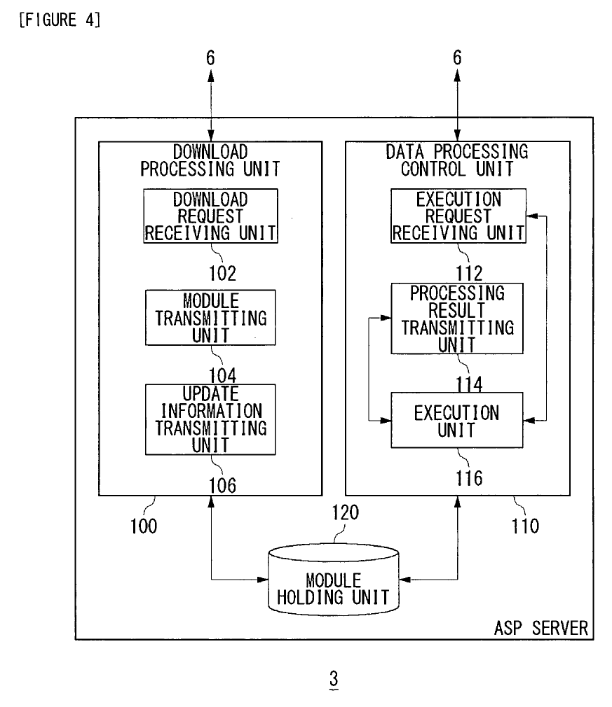

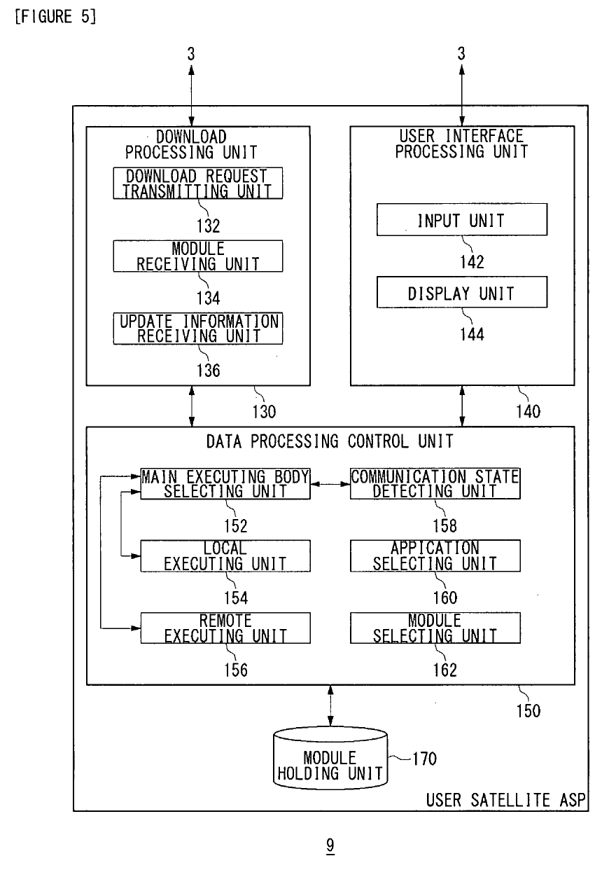

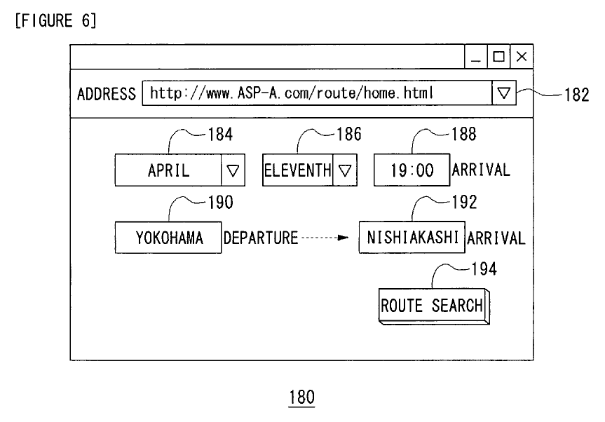

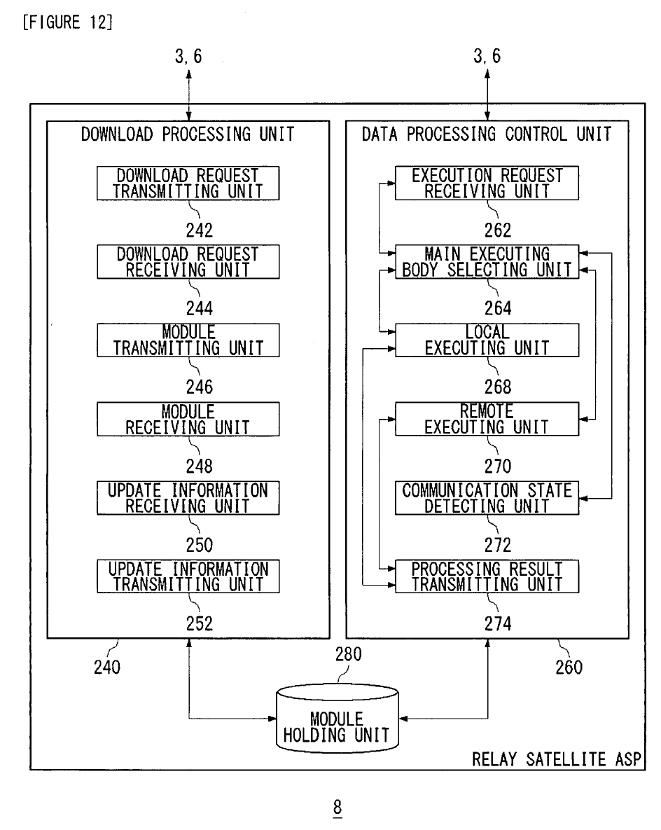

FIG. 4 is a functional block diagram of an ASP server. Although each block shown here can be realized by an element such as a CPU of a computer or a mechanical device in terms of hardware, and realized by a computer program or the like in terms of software, here are shown functional blocks realized by the cooperation therewith. Therefore, it should be understood by a person skilled in the art that these functions can be realized in various forms with combinations of software and hardware. It is the same with the functional blocks shown in FIGS. 5 and 12. Herein, functions to be performed by each block will be mainly described, and their specific actions will be described with respect to FIG. 6 or later.

An ASP server 3 includes a download processing unit 100, a data processing control unit 110, and a module holding unit 120. A module holding unit 120 holds each module. According to an example of FIG. 3, a module holding unit 120 holds each data of the modules A to D. The download processing unit 100 is in charge of download processing for transmitting module data to the user satellite ASP 9. The data processing control unit 110 executes data processing in accordance with an execution request from the user satellite ASP 9.

The download processing unit 100 includes a download request receiving unit 102, a module transmitting unit 102, and an update information transmitting unit 106. The download request receiving unit 102 receives download request data from the user satellite ASP 9 for requesting download of a module. Download request data include a terminal ID for identifying a user terminal 6 and a module ID for identifying a module. The module transmitting unit 104 reads out a module designated in the download request data from the module holding unit 120, and transmits the module to the user satellite ASP 9. The update information transmitting unit 106, when the module data in the module holding unit 120 has been updated, transmits the update information indicating that the module data has been updated, to the user satellite ASP 9. The update information includes an ID of a module which has been an update target. A module in the module holding unit 120 may be updated appropriately in accordance with a version upgrade or a correction of a bug. The update information transmitting unit 106 transmits update information to the user satellite ASP 9, when module data has been updated in such a way.

The data processing control unit 110 includes an execution request receiving unit 112, a processing result transmitting unit 114 and an execution unit 116. The execution request receiving unit 112 receives the processing request information for requesting an execution of a task by a module, from the user satellite ASP 9. Data processing, which is to be executed following an input of a user in the user satellite ASP 9, is comprised of one or more tasks. A task may be defined by setting an access to the method of each module as a unit. A task is executed by any module, for example, data processing to be executed by an input operation might be realized by a series of accesses to the method 1 of the module A, the method 3 of the module B, the method 5 of the module C, and the method 2 of the module A. A task is executed in accordance with a module, a method, and a designation of a parameter to be passed to a method. That is why the processing request information includes a terminal ID, an application ID for identifying an application, a module ID of a module to be a main executing body of a task, a method for executing a task, and a parameter necessary for executing a task, and so forth. The execution unit 116 allows the corresponding module in the module holding unit 120 to execute a task in accordance with processing request data.

The processing result transmitting unit 114 transmits processing result information showing the result of the processing to the user satellite ASP 9. The execution request receiving unit 112 may receive continuously a plurality of items of processing request information from the user satellite ASP 9. Further, if possible, the execution unit 116 may execute each task according to a plurality of items of the processing request information, in a different order from the order of receiving information.

FIG. 5 is a functional block diagram of the user satellite ASP 9. The user satellite ASP 9 includes a download processing unit 130, a user interface processing unit 140, a data processing control unit 150 and a module holding unit 170. The download processing unit 130 is in charge of processing for downloading a desirable module from the ASP server 3. The module holding unit 170 holds a module downloaded. In an example of FIG. 3, the module holding unit 170 in the user satellite ASP 9 can be said to hold each data of a module A and a module B. The user interface processing unit 140 is in charge of user interface processing for interfacing with a user in the user terminal 6. The data processing control unit 150 is in charge of a variety of data processing according to a user's request. In addition, the data processing control unit 150 also plays a role as an interface among the download processing unit 130, the user interface processing unit 140 and the module holding unit 170.

The user interface processing unit 140 includes an input unit 142 and a display unit 144. The input unit 142 detects an input operation from a user. The display unit 144 displays a variety of screens for a user. The download processing unit 130 includes the download request transmitting unit 132, the module receiving unit 134 and the update information receiving unit 136. The download request transmitting unit 132 transmits download request information for requesting a download of a module to the ASP server 3. The module receiving unit 134 downloads data of a module from the ASP server 3, the downloaded data being held in the module holding unit 170. The update information receiving unit 136 receives the update information from the ASP server 3.

The data processing control unit 150 includes a main executing body selecting unit 152, a local executing unit 154, a remote executing unit 156, a communication state detecting unit 158, an application selecting unit 160, and a module selecting unit 162. The main executing body selecting unit 152 identifies a module to be a main executing body in accordance with a user's input, when the input unit 142 detects a user's input. The main executing body selecting unit 152 may also identify a module to be a main executing body by intercepting a network access of the normal browser which is installed in the user terminal 6. Data processing is composed of one or more tasks, therefore, the number of the module, which is identified to be the main executing body, is not necessarily limited to one. For example, executing a task by a module A may be followed by executing another task by a module B, or these tasks may be executed asynchronously. The communication state detecting unit 158 detects a communication state between the user terminal 6 and the ASP server 3. Although the detailed description will be made later, the main executing body selecting unit 152 gives the priority to selecting a local module rather a remote module, as the main executing body, when the communication state is not preferable.

The local executing unit 154 allows a corresponding module in the module holding unit 170 to execute a task, when the main executing body selecting unit 152 selects a local module (hereinafter, allowing a local module to execute a task is referred to as “local execution”). The remote executing unit 156 transmits processing request information and receives the processing result information, to/from the ASP server 3, when the main executing body selecting unit 152 selects a remote module (hereinafter allowing a remote module to execute a task is referred to as “remote execution”).

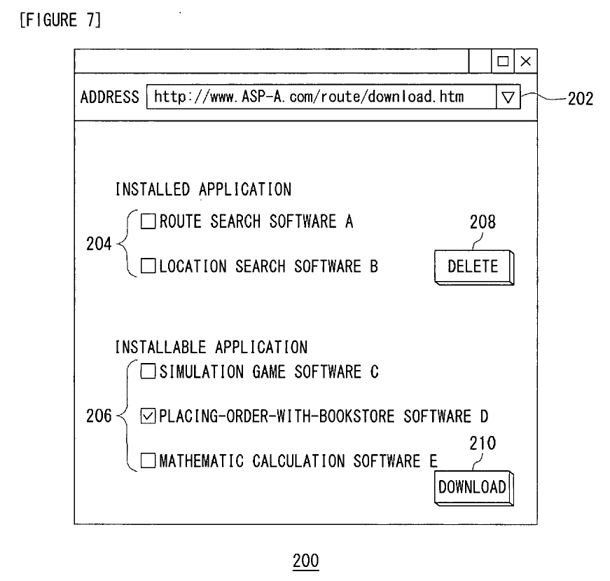

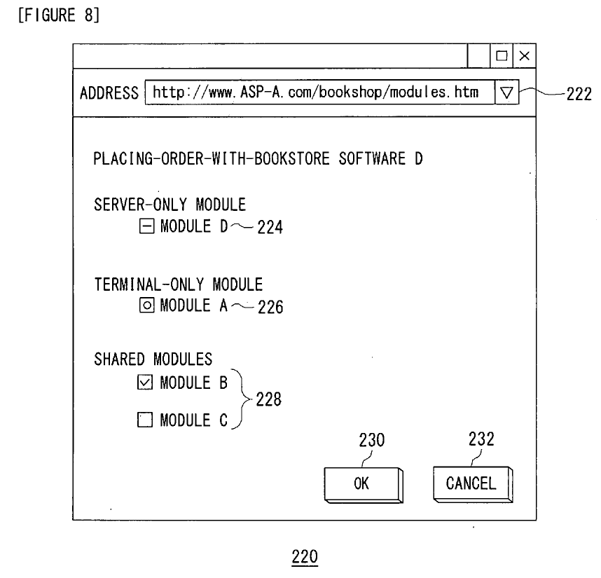

The application selecting unit 160 selects an application to be a downloaded target, in accordance with a user's selection. The module selecting unit 162 selects a module to be a download target in accordance with a user's selection. Detailed description will be made later with respect to FIG. 7 and FIG. 8.

The user satellite ASP 9 is installed as a platform on the OS (operating system). Various software such as necessary modules are installed on the user satellite ASP 9 as a platform.

When these modules or locally installed software attempt to access to an external apparatus by designating a communication address such as a URL, the user satellite ASP 9 intercepts the URL. When a URL of the ASP server 3 is designated, the main executing body selecting unit 152 selects either a local module or a remote module. When a URL of the ASP server is not designated, the main executing body selecting unit 152 transfers the processing to the OS etc. directly. Multiple types of the ASP server 3 may exist, therefore, multiple types of URLs to be intercepted, may be set.

FIG. 6 is a screen view which shows an input screen for searching for routes with respect to a route search application installed in the user satellite ASP. Now it is assumed that a route search software, which is an application for searching for routes from the departure place to the destination place, is installed in the user satellite ASP 9. The URL of the ASP server 3 is assumed provisionally to be “http://www.ASP-A.com”, and the address of the route search application A to be provisionally “http://www.ASP-A.com/route”. When the “http://www.ASP-A.com/route/home.html” is designated in the address input box 182, as shown in the same Figure, an route search input screen 180, which is provided by the route search application A in the ASP server 3, is displayed. Additionally, all URLs shown in this specification should be provisional addresses only for the use of explanations.

The month designating box 184 is one for designating the month of the arrival time, the date designating box 186 for the day, the time designating box 188 for the time, the departure place designating box 190 for the departure place, and the destination place designating box 192 for the destination place. A user inputs these search conditions in each box.

When a user clicks the route search button 194, the process for searching for routes is executed under the designated conditions. In a case under the search conditions shown in the same Figure, route information from “Yokohama” to “Nishiakashi” by the transportation such as trains or flights is displayed on the screen. At the time, the time required and the expenses necessary for traveling from Yokohama to Nishiakashi are also calculated. The main executing body of each task that makes up the processing with respect to the route search, may be a local module or a remote module. When a user clicks the route search button 194, the main executing body selecting unit 152 in the user satellite ASP 9 will identify each module that is to be a main executing body for one or more tasks. A local execution by the local executing unit 154 or a remote execution by the remote executing unit 156 will be then executed, eventually leading to the screen display of the final processing result by the display unit 144.

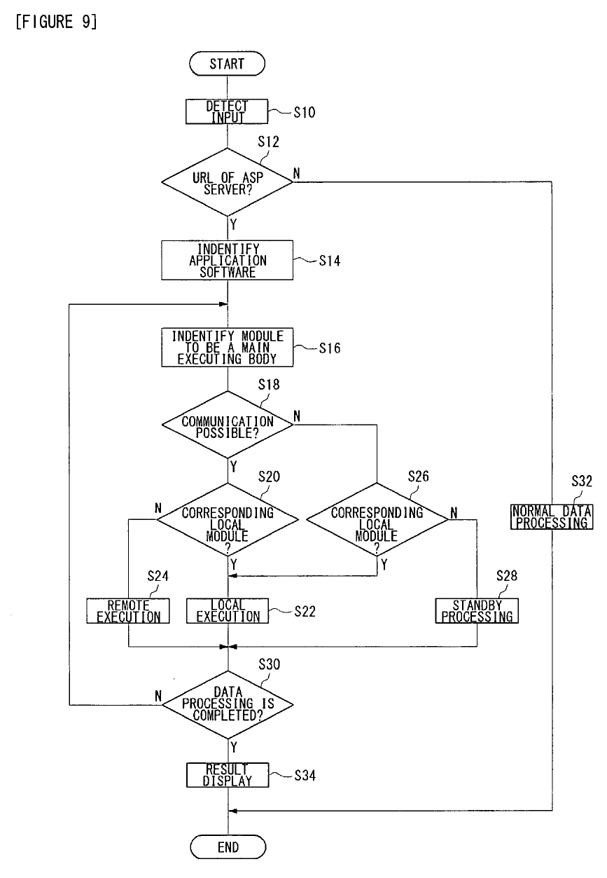

There is no substantial difference in the input interface of a screen displayed as the route search input screen 180 between the cases in which the executing body is a local module or a remote module. In the route search input screen 180, a user is not required to be aware of whether data processing will be executed by a local module or a remote module. If the URL of the ASP server 3 is designated in the address input box 182, the data processing in practice might be executed by a local module. That is, the main executing body selecting unit 152 in the user satellite ASP 9 automatically selects a main executing body, if a user does not designate the location of a module to be a main executing body. The selection policy by which the main executing body selecting unit 152 should select a main executing body, will be described later in detail with respect to FIG. 9 and so forth.

FIG. 7 is a screen view which shows an application selection screen for selecting an application to be installed in the user satellite ASP. A user selects an application from which the user would like to benefit, in the application selection screen 200. In the address input box 202, when “http://www.asp-a.com/download.htm” is designated, as shown in FIG. 7, an application selection screen 200 will be displayed. According to the sane Figure, it can be understood that the ASP server 3 can provide five applications: a route search software A, a location search software B, a simulation game software C, a placing-order-with-bookstore software D and a mathematic calculation software E. Of the five applications, a route search software A and a location search software B that are displayed in the installed application display region 204, are already installed in the user satellite ASP 9. On the other hand, a simulation game software C, a placing-order-with-bookstore software D and a mathematic calculation software E that are displayed in the installable application display region 206, are not yet installed in the user satellite ASP 9.

A user can select an application to be an uninstall target, in the installed application display region 204. After selection, when clicking the delete button 208, a selection screen (not shown) on which a module to be deleted from the user satellite ASP 9 will be selected, of the local modules installed related to the application, will be displayed. In the screen, a user can delete some of the local modules from the module holding unit 170 in the user satellite ASP 9. For example, if the terminal-only module of the route search software A already installed is requested to be deleted, the route search software A will be completely uninstalled from the user satellite ASP 9. Thus, the route search software A will be displayed in the installable application display region 206 from next time.

In the installable application display region 206, a user can select an application to be a new install target. After selection, when turning on the download button 210, an input screen for installing the selected application in the user satellite ASP 9, will de displayed. The screen will be described later with respect to FIG. 8.

FIG. 8 is a screen view which shows a module selection screen for selecting a module to be installed in the user satellite ASP. The display unit 144 of the user satellite ASP 9 displays a module selection screen 220, when turning on the download button 210 in an application selection screen 200. A user selects a module to be a download target in the module selection screen 220. Hereinafter, a module selection screen 220 on which the placing-order-with-bookstore software D shown in the application selection screen 200 will be newly downloaded, will be described.

The address display box 222 displays the URL: “http://www.ASP-A.com/bookshop/modules.htm” that displays the module selection screen 220 of the placing-order-with-bookstore software D in the user satellite ASP 3. The placing-order-with-bookstore software D is comprised of 4 modules: the module A to the module D, in the same way as the type of application explained with respect to FIG. 3. The module D displayed in the server-only module display region 224, can not be downloaded since the module is solely used for the server. The module A displayed in the terminal-only module display region 226 is always to be a download target on installing the placing-order-with-bookstore software D, since the module A is solely used for the terminal. The module B and the module C displayed in the shared module display region 228 are the shared modules that are executable in the ASP server 3 or the user satellite ASP 9. A user selects a shared module to be downloaded in the shared module display region 228, in accordance with the processing environment in the user terminal 6, such as the processing capabilities, memory capacity, and communication capacity, or the like. After selection, when turning on the OK button 230, a module selected in the shared module display region 228 will be downloaded from the ASP server 3 to the user satellite ASP 9. On the other hand, when turning on the cancel button 232, the application selection screen 200 will be back again without download processing.

FIG. 9 is a flow chart showing a data processing process in the user satellite ASP in the first embodiment. The input unit 142 of the user satellite ASP 9 detects a user's input in various input fields displayed in the route search input screen 180 or the like (S10). At the time, the main executing body selecting unit 152 of the user satellite ASP 9 determines whether an URL designated in the address input box 182 etc. is an URL of the ASP server 3 or not (S12). If an URL of the ASP server is not designated (S12/N), a normal data processing will be executed. The referred “normal data processing” is a general process performed by the user satellite ASP 9 without cooperating with the ASP server 3. On the other hand, if an URL of the ASP server 3 is designated (S12/Y), the main executing body selecting unit 152 of the user satellite ASP 9 designates an application to be an execution target (S14). For example, as explained with respect to FIG. 6, if the URL is “http://www.ASP-A.com/route”, the route search software A is identified.

The main executing body selecting unit 152 identifies a module to be a main executing body of data processing in the identified application (S16). If a data processing is executed in response to an input, each processing shown in from S16 to S30 will be executed in all tasks that make up the designated data processing. The tasks will be explained on the assumption that they will be executed basically in turn. First, identifying a main executing body of a first task (S16) will be followed by the detection of whether communication with the ASP server is possible, by the communication state detecting unit 158 of the user satellite ASP 9 (S18). If the communication is possible (S18/Y), the main executing body selecting unit 152 determines whether the module identified as the main executing body of the task is located as a local module or not (S20). If the module is held as a local module (S20/Y) the local executing unit 154 allows the corresponding local module to execute the task (S22). If the module is not held as a local module (S20/N), the remote executing unit 256 allows the task to be remotely executed, by transmitting processing request data to the ASP server 3 (S24).

In S24, when the executing request receiving unit 112 in the ASP server 3 receives the processing request information, the executing unit 116 in the ASP server 3 executes the task by the corresponding module, thereafter, the processing result transmitting unit 114 in the ASP server 3 transmits the processing result information to the user satellite ASP 9. The remote executing unit 156 of the user satellite ASP 9 receives the processing result information, thereby the task being executed by the remote module.

On the other hand, if it is determined that communication is impossible in S18 (S18/N), the main executing body selecting unit 152 in the user satellite ASP 9 determines whether the module identified as the main executing body is held as a local module or not (S26). If the module is held (S26/Y), the process moves to S22 followed by a local execution. If the module is not held (S26/N), the process is put on standby (S28). In this case, the execution of a task may be put on standby until the communication becomes possible. Or, another task may be executed first by moving the task behind in the order of execution. A task to be a local execution target or another task to be a remote execution target can be interchangeable in accordance with the communication state, which makes the a data processing more efficient as a whole, since if the communication is not possible, a local execution is assigned high priority.

When the data processing, a series of tasks with the input operation in S10, is not completed yet (S30/N), the process will return to S16, followed by identifying the main executing body of the next task. At the time, for example, a task to be a remote execution target, which has been put on standby in S28 and moved behind, may be retried. When the data processing has been completed (S30/Y), the display unit 144 displays a processing result on the screen (S34). Thus, a plurality of tasks will be executed in turn, which leads to the execution of data processing in response to the input operation.

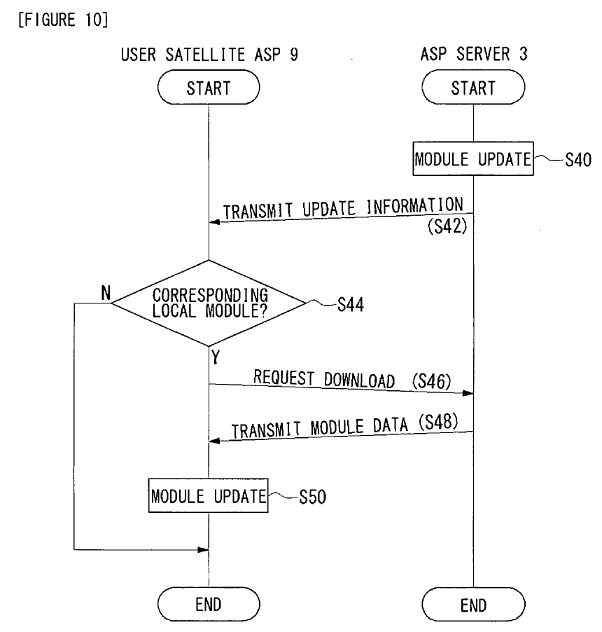

FIG. 10 is a sequence diagram which shows a process in which the user satellite ASP updates a local module in the first embodiment. A modules held by the ASP server 3 is updated appropriately with a version-upgrade etc (S40). At the time, the update data transmitting unit 106 in the ASP server 3 transmits update information including a module ID of the updated module, to the user satellite ASP 9 (S42). The update information receiving unit 136 in the user satellite ASP 9 receives the update information and determines whether the module to be an update target is held as a local modules or not (S44). When it is not held (S44/N), the update of a local module is not executed. When it is held (S44/Y), the download request transmitting unit 132 in the user satellite ASP 9, transmits a download request for downloading the updated module to the ASP server 3 (S46). When the download request receiving unit 102 in the ASP server 3 receives the download request, the module transmitting unit 104 transmits the data of the requested module to the user satellite ASP 9 (S48). The module receiving unit 134 in the user satellite ASP 9 receives the module data and updates the corresponding module in the module holding unit 120 with the newly received data (S50). Thus, an update of a module in the ASP server 3 is reflected on a module in the user satellite ASP 9.

### Second Embodiment

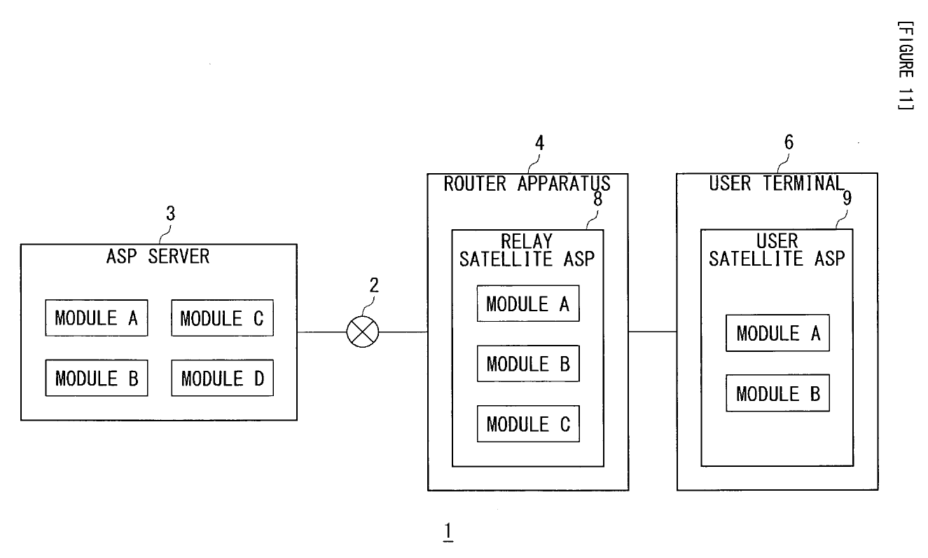

FIG. 11 is a diagram which shows a structure of an application software, in a data processing system according to the second embodiment.

Unlike the first embodiment, a router apparatus 4 for intermediating between the ASP server 3 and a user terminal 6 is further included in the structure. In the second embodiment, a relay satellite ASP 8 is introduced into the router apparatus 4, and a user satellite ASP 9 into the user terminal 6, and an application will be executed by the cooperation of the ASP server 3, the relay satellite ASP 8 and the user satellite ASP 9.

Data of the modules A to D that make up an application are held in the ASP server 3. Of the modules, the relay satellite ASP 8 that is software introduced into the router apparatus 4 has downloaded the modules A to C from the ASP server 3. Further, the user satellite ASP 9 has downloaded the modules A and B out of the modules A to C held in the relay satellite ASP 8. In an embodiment shown in the same Figure, the application software will be basically executed by the modules A and B in the user satellite ASP 9, the module C in the relay satellite ASP 8 and the module D in the ASP server 3.

Herein, of the modules A to D, the module A, which is executable only in the user satellite ASP 9, is a terminal-only module. The modules B and C are shared modules that are executable in any one of the ASP server 3, the relay satellite ASP 8 and the user satellite ASP 9. Further, the module D, which is executable only in the ASP server 3, is a module solely used for a server. Data that should be controlled solely in the ASP server 3, will be controlled by the module D.

In addition, as in the first embodiment, each module may be executed by a plurality of ASP servers, rather a single ASP server 3. Furthermore, each module may be executed by a plurality of router apparatuses 4, rather a single router apparatus 4.

FIG. 12 is a functional block diagram of a relay satellite ASP. A relay satellite ASP 8 includes the download processing unit 240, the data processing control unit 260 and the module holding unit 280. The module holding unit 280 holds each module. According to the example of FIG. 11, the module holding unit 280 holds each data of the modules A to C. The download processing unit 240 is in charge of transmitting/receiving module data to/from the ASP server 3 and the user satellite ASP 9. The data processing control unit 260 executes a data processing in response to a data processing execution request from the user satellite ASP 9.

In addition, a module held in the relay satellite ASP 8 is herein referred to as a “local module”, and a module held in the ASP server 3, which is superior to the relay satellite ASP 8, referred to as a “remote module”, from a view of the relay satellite ASP.

The download processing unit 240 includes a download request transmitting unit 242, the download request receiving unit 244, the module transmitting unit 246, the module receiving unit 248, the update information receiving unit 250 and the update information transmitting unit 252. The download request transmitting unit 242 transmits download request information to the ASP server 3. The download request receiving unit 244 receives the download request information from the user satellite ASP 9 to the router apparatus 4. The module transmitting unit 246 transmits the module that is requested for downloading, to the user satellite ASP 9. The module receiving unit 248 receives the module from the ASP server 3. The update information receiving unit 250 receives the update information from the ASP server 3. The update information transmitting unit 252 forwards the update information received from the ASP server 3, to the user satellite ASP 9.

The data processing control unit 260 includes the execution request receiving unit 262, the main executing body selecting unit 264, the local execution unit 268, the remote execution unit 270, the communication state detecting unit 272 and the processing result transmitting unit 274. The execution request receiving unit 262 receives the processing request information from the user satellite ASP 9. The main executing body selecting unit 264 selects a module to be a main executing body of the task, according to the processing request information. The local execution unit 268 allows a local module in the module holding unit 280 to execute a task when a local module is selected as the main executing body. The remote execution unit 270 allows a remote module held in the ASP server 3 to execute a task requested by the processing request information, and receives a processing result as processing result information. The communication state detecting unit 272 detects whether a communication between the router apparatus 4 and the ASP server 3 is possible. The processing result transmitting unit 274 transmits a result of a task executed by the local execution unit 268 or the remote execution unit 270, to the user satellite ASP 9, as processing result information.

In addition, in the second embodiment, the functional blocks of the ASP server 3 and the user satellite ASP 9 are the same as the contents described with respect to FIG. 4 and FIG. 5.

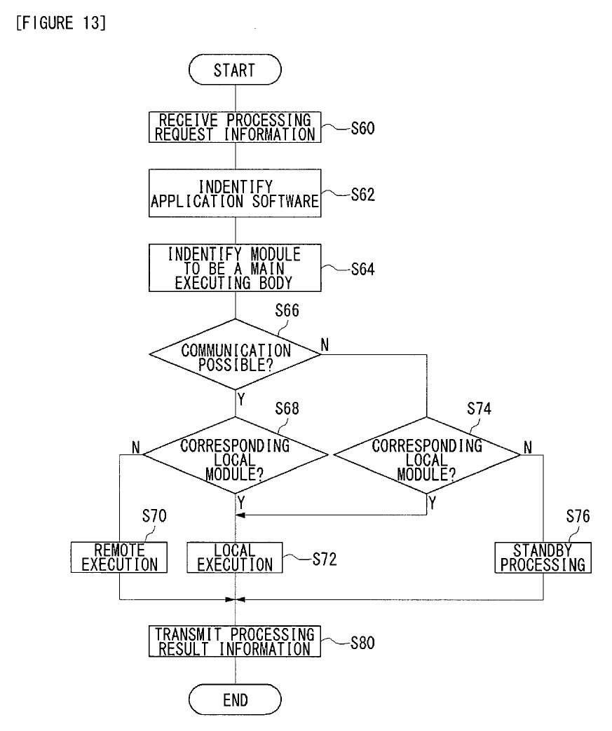

FIG. 13 is a flow chart showing a data processing process in the user satellite ASP, in the second embodiment. As described with respect to FIG. 9, if a data processing could be executed by a module held in the user satellite ASP 9, it is also possible that all tasks would be executed by the user satellite ASP 9 alone. On the other hand, if a desirable data processing can not be executed by the modules alone held in the user satellite ASP 9, processing request information will be transmitted to the router apparatus 4 appropriately. In the second embodiment, a data processing is composed of one or more tasks. Each task will be executed by some of the modules.

The execution request receiving unit 262 in the relay satellite ASP 8 first receives the processing request information from the user satellite ASP 9 (S60). The main executing body selecting unit 264 identifies an application to be an execution target (S62). The main executing body selecting unit 264 then identifies a module to be an executing body of the designated task in the identified application (S64).

The remote execution unit 270 of the relay satellite ASP 8 detects whether the communication with the ASP server 3 is possible (S66). If possible (S66/Y), the main executing body selecting unit 264 determines whether the module identified as the main executing body is held as a local module or not (S68). If the module is held (S68/Y), the local execution unit 268 requests the corresponding local module to execute a local execution of the task (S72). If the module is not held (S68/N), the remote execution unit 270 requests a remote execution by transmitting the processing request information to the ASP server (S 70). The processing of a remote execution referred to herein is the same as the content described with respect to S 24 of FIG. 9. That is, when the execution request receiving unit 112 in the ASP server 3 receives the processing request information, the execution unit 116 will execute the task with the corresponding module in the ASP server 3. The processing result transmitting unit 114 in the ASP server 3 transmits the processing result information to the relay satellite ASP 8. The remote execution unit 270 in the relay satellite ASP 8 receives the processing result information, thus the remote execution is realized.

On the other hand, if it determined that the communication is not possible in S66, the main executing body selecting unit 264 determines whether the module identified to be the main executing body is held as a local module or not (S74). If the module is held (S74/Y), the process moves to S72, whereas if the module is not held (S74/N), the process is put on standby (S76). In this case, the execution of a task may be put on standby until the communication becomes possible, or if possible, the task execution may be moved behind in the order of execution. The processing result transmitting unit 274 transmits the processing result information to the user satellite ASP 9 (S80).

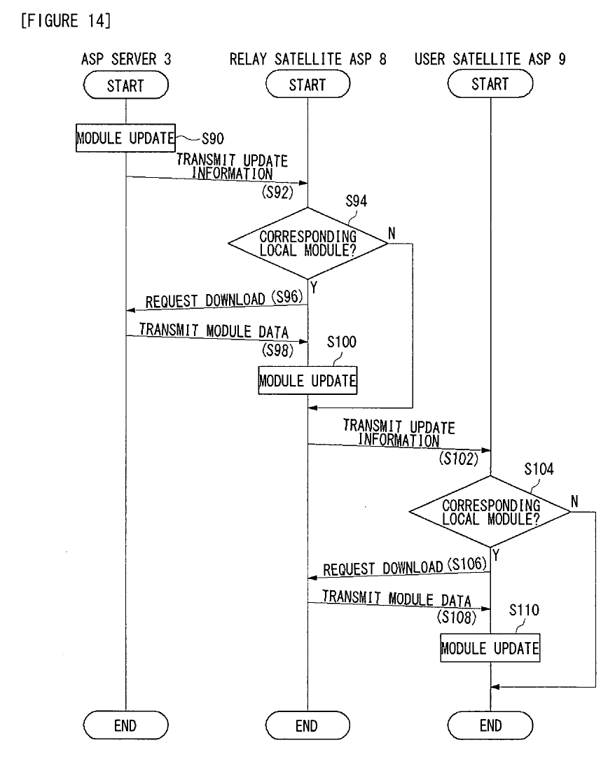

FIG. 14 is a sequence diagram which shows a process in which a relay satellite ASP or a user satellite ASP updates a module, in the second embodiment. When a module held in the ASP server 3 is updated (S90), the update information transmitting unit 106 in the ASP server 3 transmits update information to the relay satellite ASP 8 (S92). Upon receiving the update information, the relay satellite ASP 8 determines whether the module to be an update target is held as a local module (S94). If the module is not held (S94/N), an update of a local module will not be executed, whereas if the module is held (S94/Y), the download request receiving unit 244 in the relay satellite ASP 8 transmits download request information on the updated module, to the ASP server 3 (S96). When the download request receiving unit 102 in the ASP server 3 receives the download request information, the module transmitting unit 104 reads out the data of the requested module from the module holding unit 120, and transmits the data to the relay satellite ASP 8 (S98). Upon receiving the module data, the module receiving unit 248 in the relay satellite ASP 8 will update the corresponding module in the module holding unit 280 in the relay satellite ASP 8, with the newly received data (S100).

Following this, the update information transmitting unit 252 in the relay satellite ASP 8 transmits the update information received in S92, to the user satellite ASP 9 (S102). The processes shown in the following S104 to S110 are the same as the contents described with respect to FIG. 10. That is, if the user satellite ASP 9 holds a module to be an update target (S104/Y), the user satellite ASP 9 requests the relay satellite ASP 8 that the updated module be downloaded (S106). Upon receiving the data on the corresponding module from the relay satellite ASP 8 (S108), the user satellite ASP 9 updates the module data held (S110). If the corresponding module is not held (S104/N), the update of the module will not be executed. After the above-described processes, an update of a module in the ASP server 3 will be reflected on a module in the relay satellite ASP 8 or the user satellite ASP 9.

In the aforementioned embodiments, the relay satellite ASP 8 and the user satellite ASP 9 function as a proxy for the ASP server 3. The processing load to applications as a whole is dispersed into a plurality of apparatuses, such as the ASP server 3, the router apparatus 4 and the user terminal 6, which leads to the reduction in the processing load of the ASP server 3, in comparison with a conventional ASP model.

As shown in the route search input screen 180 in FIG. 6, a user accesses an application provided by the ASP server 3 by designating a URL of the ASP server 3. At the time, the relay satellite ASP 8 or the user satellite ASP 9 determines where the data processing will be in fact executed among the ASP server 3, the router apparatus 4 or the user terminal 6. A user can access a plurality of apparatuses via a single input screen without being aware of the location of an executing body.

There are further another advantages with the way of accessing an application using URLs of the ASP server 3. More specifically, disadvantages might occur in passing a process of the user terminal A to the user terminal B, when a user provisionally designates a local address such as “http://www.localhost/App-2/” in order to indicate that an executing body of a data processing is a local module. For example, it is assumed that the modules A and B are introduced in the user terminal A, while the module A alone in the user terminal B. When a macro program to use the “local” module B is created, a function with a local address, which is used for executing a task for the module B, will be created in the macro program. When executing the macro program in the user terminal B, the program becomes non-executable since the module B is not located as a local module for the user terminal B.

In contrast, the user satellite ASP 9 shown in each aforementioned embodiment, accesses an application with the URL of the ASP server 3, regardless of a local execution or a remote execution. Therefore, a macro program created in the user terminal A can be readily executed in the user terminal B. That is because the main executing body selecting unit 152 in the user satellite ASP 9 automatically selects either a local execution or a remote execution depending on the state of the user satellite ASP 9, by detecting the URL of the ASP server 3.

Even for the pieces of software having the same content, different user interfaces would often be provided by a local version of software which is assumed to be installed in the user terminal 6, and by an ASP version of software which is assumed to be provided as an ASP by the ASP server 3. For example, the user interface of a local version is provided using a widget such as a dialog box, menu bar or tool bar or the like, whereas the user interface of an ASP version of software is provided as a web browser. Therefore, a user must be familiar with two types of user interfaces for the software having the same content.

In contrast, the user satellite ASP 9 in each aforementioned embodiment provides a user interface screen as a uniform screen, preferably, as a Web screen, regardless of a local execution or a remote execution, which leads to the reduction in such user's burdens. The user satellite ASP 9 may have a function of displaying a screen shown in FIG. 6 etc., or may request the existing web browser to display a screen.

The user satellite ASP 9 is not required to download all modules in the ASP server 3. The processing performance from a view of a user can be improved by downloading a module, which requires high responsiveness or is used so frequently, among various modules. Even if any of local modules are uninstalled from the user satellite ASP 9, the execution of an application can be continued by a remote module.

Access to an application may be limited only to the access to the URL: “http://www.ASP-A.com/app-1”, and an accessible local storage from the application may be limited to the folder: “d¥app-A/data”. In other words, the application is permitted to access only the folder: “d¥app-A/data”. In such a way, by limiting the accessible regions from a local module and a remote module, the security in the so-called sandbox model can be improved.

In a conventional ASP model, there is a weak point that services can not be provided when the communication is cut-off. In contrast, in the data processing system 1 shown in each aforementioned embodiment, since a local module acts as a proxy in executing a part of the data processing, the situation in which services can not be provided immediately after the communication is cut-off, is readily avoided. Such a structure is especially effective when a user terminal is a mobile terminal.

In a conventional ASP, access to a client resource tends to be limited, however, in the data processing system 1 shown in the aforementioned embodiments, the cooperation between the client resource and the server source can be promoted more effectively.

In each aforementioned embodiment, it is described that an application is executed by the cooperation among each module of the ASP sever 3, the user satellite ASP9, and the relay satellite ASP 8, however, it is needless to say that a main module may be executed in the ASP server 3. For example, in a user terminal 6, a user’ input operation for the web browser may be directly transmitted to the ASP server 3, and the ASP server 3 may execute a data processing in accordance with the content of the input operation and display the processing result, in the same way as the conventional ASP.

The present invention has been described above with reference to the embodiments. It should be understood by a person skilled in the art that any combination of the aforementioned components or any manifestation of the present invention realized by modifications of a device, system, and so forth, is effective as an embodiment of the present invention and those modifications are also within the scope of the present invention.

In addition, the functions of the first external apparatus described in claims are realized by the ASP server 3 in the second embodiment. Likewise, the second external apparatus is realized by the user terminal 6 in the second embodiment. It should also be understood by a person skilled in the art that these functions, which should be performed by each element described in claims, can be realized by either each functional block itself shown in the present embodiments or the cooperation thereof.

According to the present invention, a technique that reduces the load to a server offering application services can be provided.

1. A data processing apparatus comprising:
means for acquiring an application, which has a function equal to or a part of an application that is executed by a server to provide services, from a server via a net work, and installing the application;
means for acquiring a request to the server, and executing the application instead of the server.

2. The data processing apparatus according to claim 1, wherein the application is installed in a client's terminal.

3. The data processing apparatus according to claim 1, wherein the application is installed in an apparatus connected between a client's terminal and the server.

4. A data processing apparatus comprising:
a module acquisition unit that downloads at least some of a plurality of functional modules which make up an application software, from an external apparatus;
an input screen display unit that displays an input screen for accepting an input operation from a user;
an operation detecting unit that detects a user's input operation on the input screen;
a main executing body selecting unit that selects at least either of a local module, which is a functional module downloaded to the apparatus itself or a remote module, which is a functional module stored in an external apparatus, depending on whether a local module, which is capable of executing the data processing, is located or not, as the main executing body for the data processing in accordance with the user's input operation;
a local execution control unit that makes the local module execute the data processing in accordance with the user's input operation, when a local module is selected as the main executing body;
a remote execution control unit that transmits processing request information for requesting an external apparatus to execute the data processing in accordance with the user's input operation, and receives the resulting information of the data processing from the external apparatus, when a remote module is selected as the main executing body; and
a result display unit that displays a result of the data processing executed by at least either of a local module or a remote module on the screen, wherein the main executing body selecting unit selects at least either of a local module or a remote module, even when a user's input does not include information that can identify either of a local module or a remote module as the main executing body.

5. The data processing apparatus according to claim 4, wherein at least some of functional modules, which are to be download targets as a local module, are executable in both an external apparatus and an apparatus itself.

6. The data processing apparatus according to claim 4, wherein the input screen display unit display an input screen as a screen for indicating to transmit processing request information to an external apparatus, and the main executing body selecting unit acquires the processing request information via the input screen and select a local module as the main executing body, when the local module capable of executing the data processing in accordance with the processing request information, is located.

7. The data processing apparatus according to claim 4, wherein the main executing body selecting unit gives priority to selection of a local module as the main executing body, when the communication with an external apparatus is in an off-line state.

8. The data processing apparatus according to claim 4, wherein the input screen display unit displays an input screen in a way in which input screens for accepting an input operation for a remote module and a local module, are to be substantially the same.

9. The data processing apparatus according to claim 4, wherein the apparatus further comprises an application selecting unit that detects a user's input for selecting an application software to be executed, and the module acquisition unit sets a functional module included in the selected application software, to be a download target from an external apparatus.

10. The data processing apparatus according to claim 4, wherein the apparatus further comprises a module selecting unit that detects a user's input for selecting a functional module to be a download target, from a plurality of functional modules included in an application software, and the module acquisition unit sets the selected functional module to be a download target from an external apparatus.

11. The data processing apparatus according to claim 4, wherein the apparatus further comprises an update information receiving unit that receives the update information indicating a remote module in an external apparatus has been modified, and, the module acquisition unit freshly downloads a modified remote module, upon receiving the update information.

12. A data processing system comprising:
a data processing apparatus according to claim 4;
a server apparatus, as an external apparatus according to claim 4; wherein the server apparatus comprises:
a module holding unit that holds a plurality of functional modules that make up an application software; a module transmitting unit that transmits at least some of a plurality of the functional modules to the data processing apparatus, as a local module to be held in the data processing apparatus:
a processing request receiving unit that receives the processing request information to request an execution of a data processing, from the data processing apparatus;
an execution control unit that allows a functional module held to execute a requested data processing; and
a processing result transmitting unit that transmits a result of the data processing to the data processing apparatus, as the processing result information.

13. A data processing relay apparatus comprising:
a module acquisition unit that downloads at least some of a plurality of functional modules which make up an application software, from a first external apparatus;
a processing request receiving unit that receives processing request information for requesting an execution of a data processing, from a second external apparatus;
a main executing body selecting unit that selects either of a local module which is a functional module downloaded to an apparatus itself, or a remote module which is a functional module stored in a first external apparatus, depending on whether a local module capable of executing a data processing is located or not, as the main executing body of executing a data processing;
a local execution control unit that makes a local module execute an requested data processing, when a local module is selected as the main executing body;
a remote execution control unit that transmits processing request information for requesting a first external apparatus to execute a requested data processing, when a remote module is selected as the main executing body, and that receives resulting information showing a result of the data processing, from the first external apparatus; and
a processing result transmitting unit that transmits a processing result of a data processing by at least either of a local module or a remote module, to at second external apparatus, as the processing result information.

14. The data processing relay apparatus according to claim 13, wherein the apparatus further comprises a module transmitting unit that transmits at least some of the functional modules downloaded from a first external apparatus to a second external apparatus so that a part of the functions of an application software are set to be executable in a second external apparatus.

15. A data processing method comprising:
downloading at least some of a plurality of functional modules which make up an application software, from an external apparatus;
displaying an input screen for accepting an input operation from a user;
detecting a user's input operation on the input screen:
selecting at least either of a local module, which is a functional module downloaded to the apparatus itself, or a remote module, which is a functional module stored in an external apparatus, depending on whether a local module, which is capable of executing the data processing, is located or not, as the main executing body for the data processing in accordance with the user's input operation;
making the local module execute the data processing in accordance with the user's input operation, when a local module is selected as the main executing body;
transmitting processing request information for requesting an external apparatus to execute the data processing in accordance with the user's input operation, and receiving the resulting information of the data processing from the external apparatus, when a remote module is selected as the main executing body; and
displaying a result of the data processing executed by at least either of a local module or a remote module on the screen, wherein at least either of a local module or a remote module is selected, even when information that can identify either of a local module or a remote module as the main executing body, is not designated, when a user's input to the input screen is accepted.

16. A data processing program product comprising:
a module that downloads at least some of a plurality of functional modules which make up an application software, from an external apparatus;
a module that displays an input screen for accepting an input operation from a user;
a module that detects a user's input operation on the input screen;
a module that selects at least either of a local module, which is a functional module downloaded to the apparatus itself, or a remote module, which is a functional module stored in an external apparatus, depending on whether a local module, which is capable of executing the data processing, is located or not, as the main executing body for the data processing in accordance with the user's input operation, even when information identifying the main executing body has not been input by a user;
a module that makes the local module execute the data processing in accordance with the user's input operation, when a local module is selected as the main executing body;
a module that transmits processing request information for requesting the external apparatus to execute the data processing in accordance with the user's input operation, and that receives resulting information of the data processing from the external apparatus, when a remote module is selected as the main executing body; and
a module that displays a result of the data processing executed by at least either of a local module or a remote module, on the screen.
